(19) United States
(12) Patent Application Publication
(10) Pub. No.: US 2010/0125579 A1
(43) Pub. Date: May 20, 2010

(54) DATA STORAGE

(76) Inventors: Andrew Pardoe, Northants (GB); Jason Hart, Bedfordshire (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/294,349

(22) PCT Filed: Mar. 26, 2007
(86) PCT No.: PCT/GB07/01049

§ 371 Date: Feb. 19, 2009

(30) Foreign Application Priority Data
Mar. 25, 2006 (GB) 0606012.3

(51) Int. Cl. G06F 17/30; G06F 7/00

(52) U.S. Cl. 707/736; 707/E17.014; 707/E17.044; 707/E17.104

(57) ABSTRACT

A data storage apparatus, for allowing querying of structured data, in which the structure of the data and the values of the data are stored separately, the apparatus comprising a computer system including a memory,

a sequence of data values stored in a first location of the memory and a structural definition data stored in a second location in the memory, each data value in the record having a stored definition identifier which corresponds to at least a portion of the structural definition data, wherein the queryable structured data comprises the sequence of data values set to a structure defined by the values corresponding portion(s) of the structural definition data, such that the structure of the data and the data content/values can be altered independently by altering the structural definition data or sequence of data values respectively or by altering one or more definition identifiers.

This invention relates to a storage apparatus for querying stored data, a method of storing data, a method of defining data structure, and a method of querying data.

It is known to store data in a database. This is commonly done through a relational database or an object orientated database.

Relational databases such as SQL consists of several tables of data related to each other by foreign keys. The structure of the data is inherent in the form of the tables and is hard coded as part of the database schema.

There is an increasing need for future applications in the system to be more flexible, able to adapt to new business processes, work flows, and analyse and report on most information.

A problem with known data storage systems such as relational databases is that during their lifetime the typical cycle of software means that the majority of the time the system is implemented updates or modifications are limited to the maintenance phase and in turn by business critical requirements. The time required to make these updates and modifications is substantial, weeks or months being usual. This means that a large amount of computer processing time and power is required to implement updates.

Changes to a system or an application are typically driven by the need to make additions to or modify the business data. This could include customer data, sales information, employee data or any other data information considered as part of the business operation or workflow task.

Because the structure is hard coded in conventional systems it is difficult to make any changes to the structure without also interfering with the data content, i.e. the business data. Accordingly the manner in which data is stored and the structure is coded causes a technical obstacle to alterations to be made to either the data or structure.

It is an object of the invention to provide improvements on these. In particular it is an object to make it technically easier to change the structure of the database.

According to the first aspect of the invention there is provided a data storage apparatus, for allowing querying of structured data, in which the structure of the data and the values of the data are stored separately, the apparatus comprising a computer system including a memory, a sequence of data values stored in a first location of the memory and a structural definition data stored in a second location in the memory, each data value in the record having a stored definition identifier which corresponds to at least a portion of the structural definition data, wherein the queryable structured data comprises the sequence of data values set to a structure defined by the values corresponding portion(s) of the structural definition data, such that the structure of the data and the data content/values can be altered independently by altering the structural definition data or sequence of data values respectively or by altering one or more definition identifiers.

Further preferred features are set out in the dependent claims.

The embodiments of the invention will now be described by way of example only with reference to the accompanying schematic drawings in which:

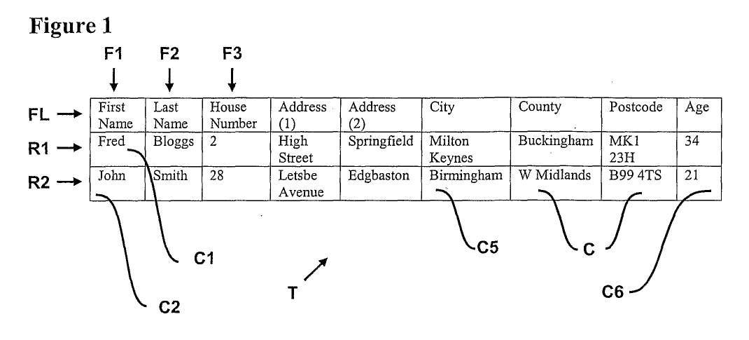

FIG. 1, is a view of a conventional database table containing data

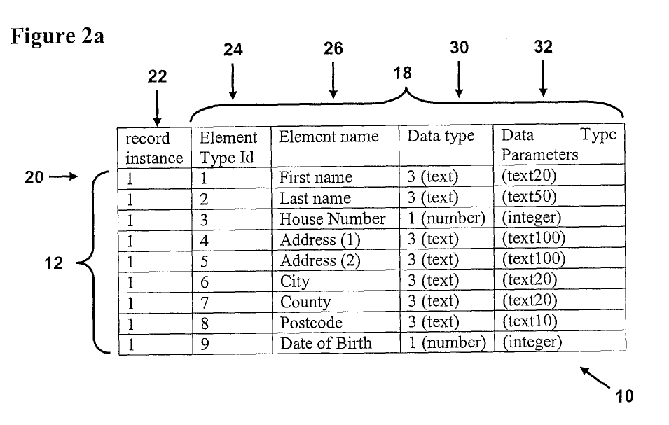

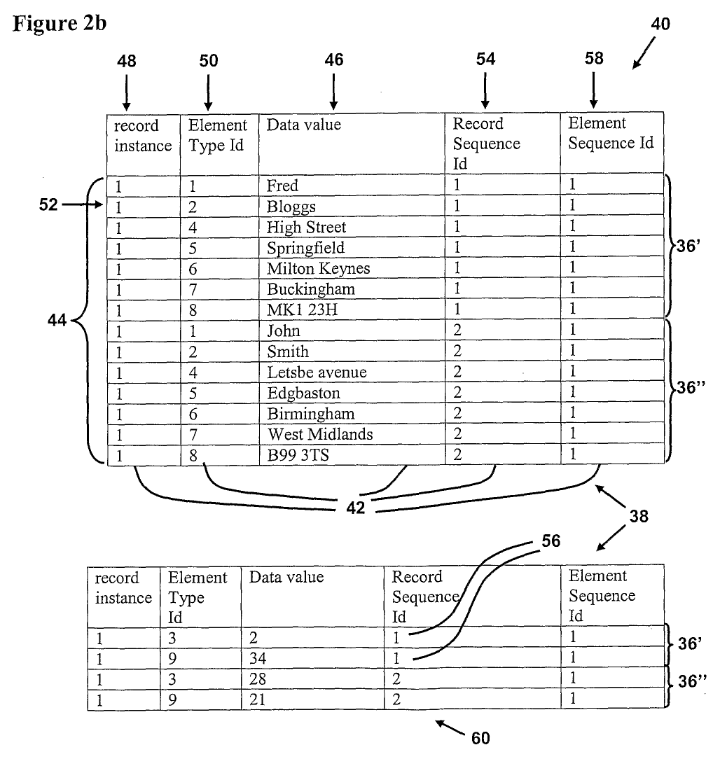

FIGS. 2a, and 2b show equivalent data and structure being stored in accordance with the invention;

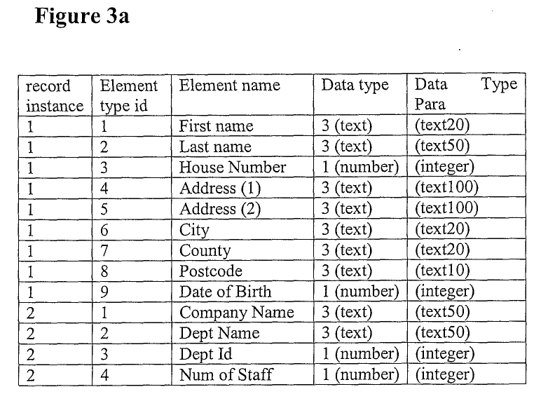

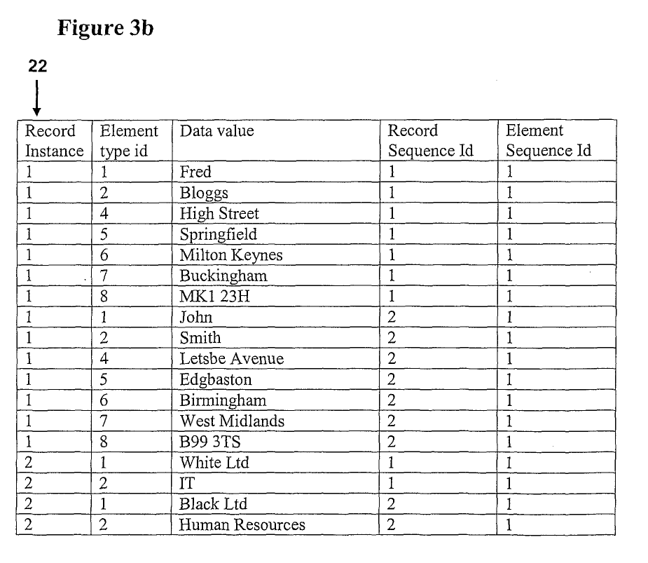

FIGS. 3a and 3b show the tables of FIGS. 2a and 2b with an additional record instance;

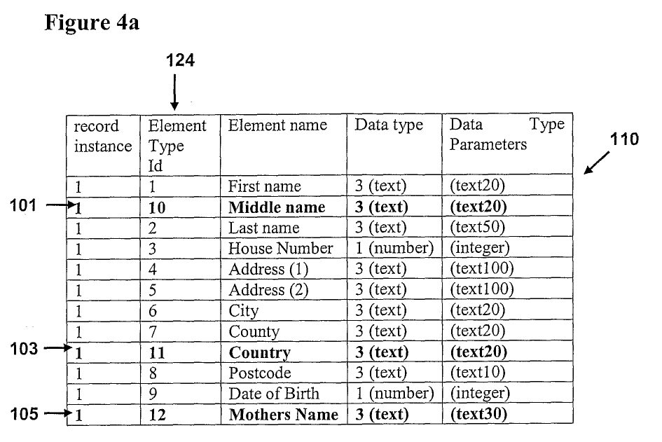

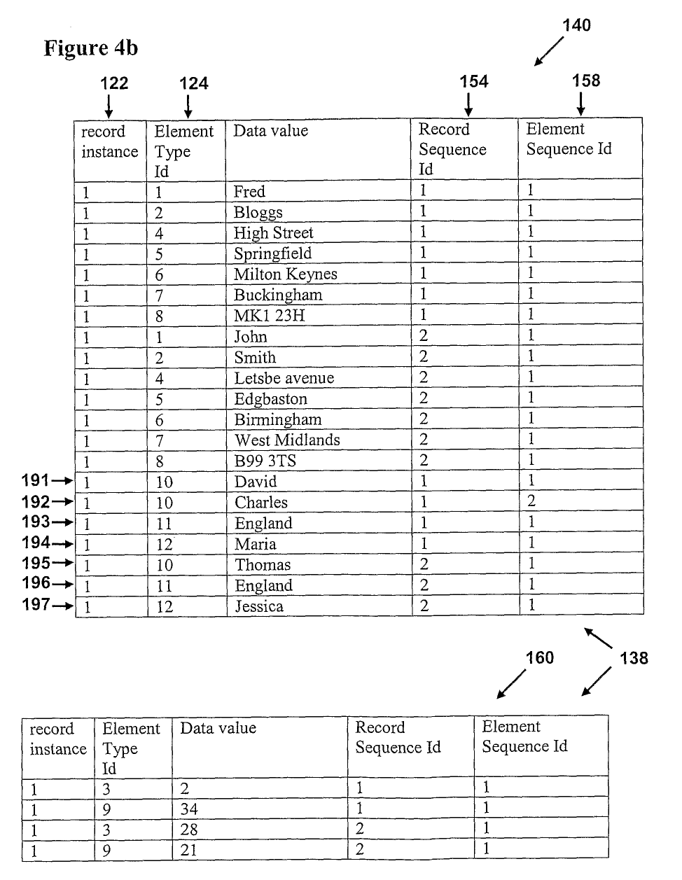

FIGS. 4a and 4b show altered changes to the structure and business data of FIGS. 2a, and 2b;

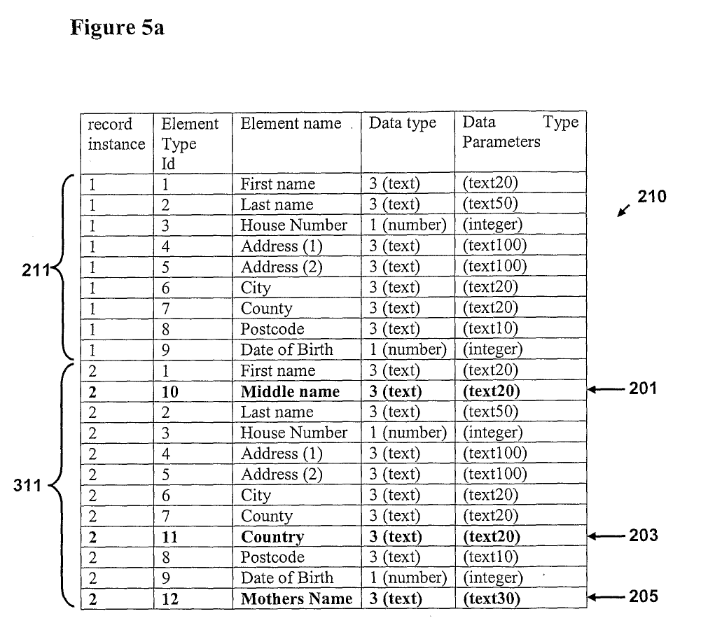

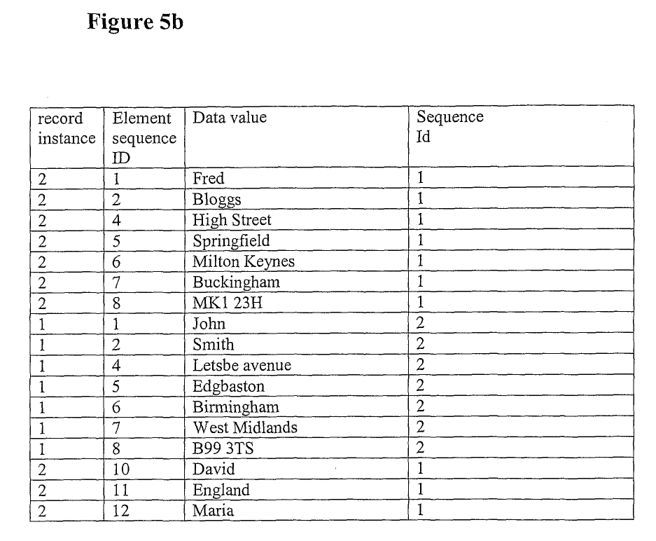

FIGS. 5a and 5b show a second embodiment of changes to the structure and business data of FIGS. 2a and 2b;

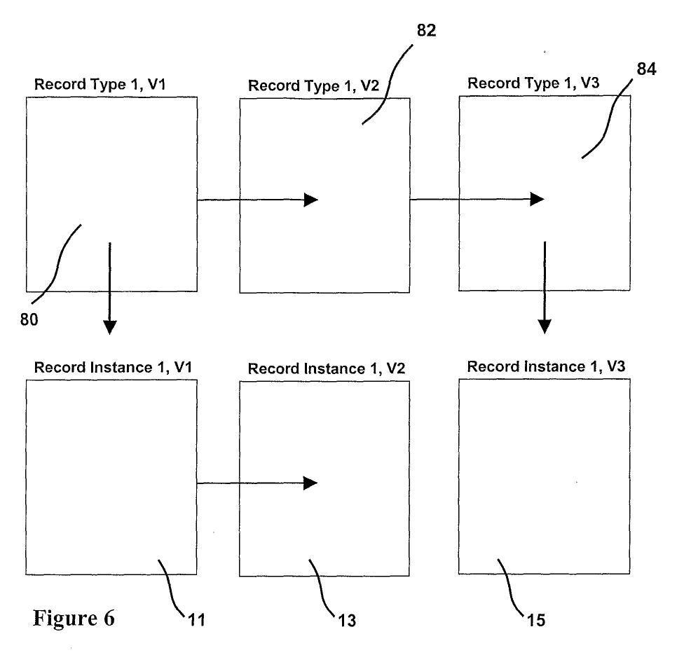

FIG. 6 is an illustration of versioning of record types and instances

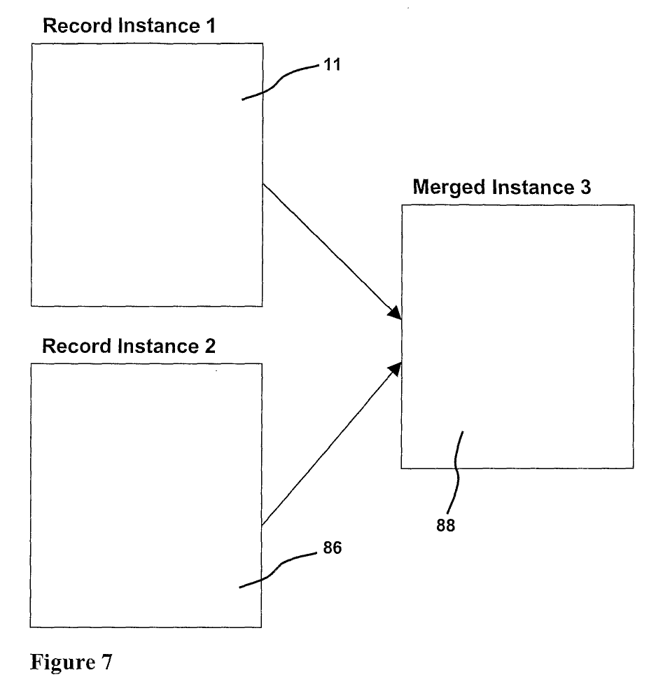

FIG. 7 is a an illustration of merging instances;

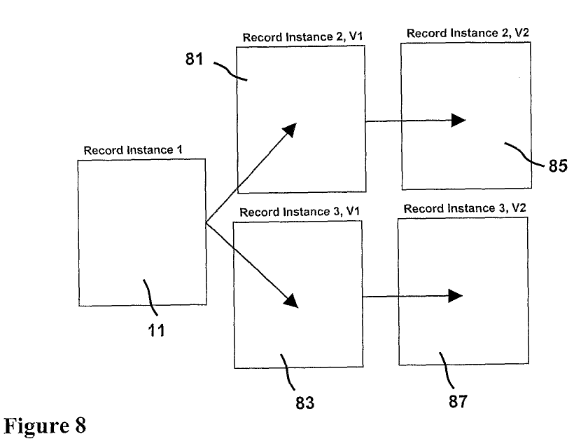

FIG. 8 is an illustration of separating instances;

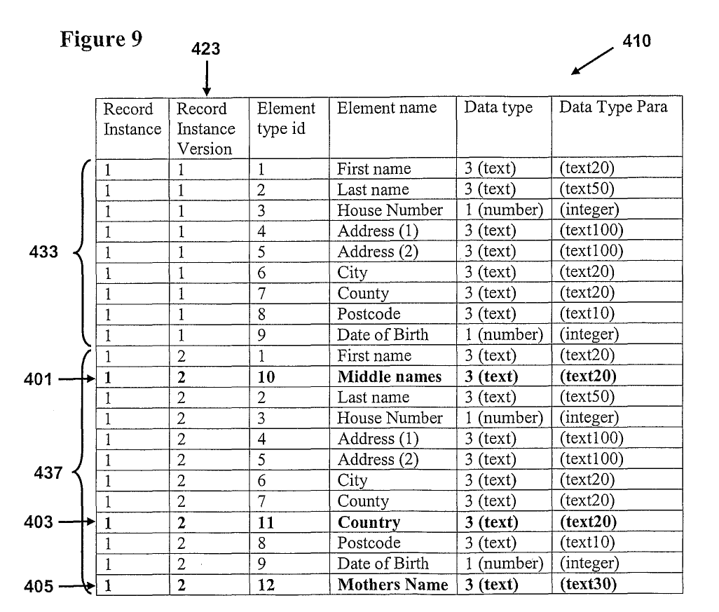

FIG. 9 show a third embodiment of changes to the structure and business data of FIGS. 2a and 2b using versioning;

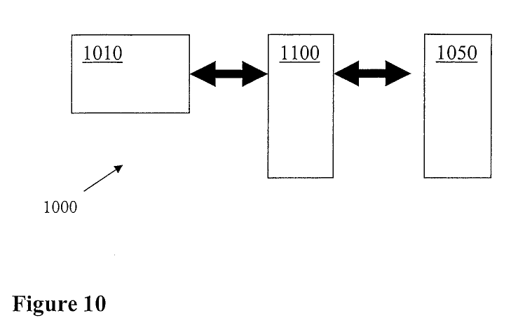

FIG. 10 depicts the invention in a three tier client server hardware configuration;

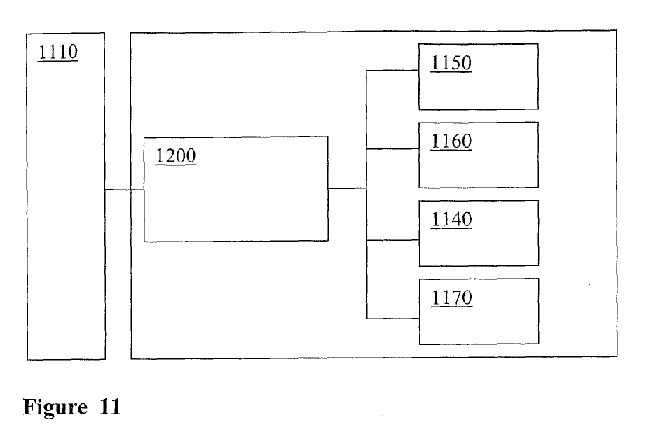

FIG. 11 is a view of the server of FIG. 10;

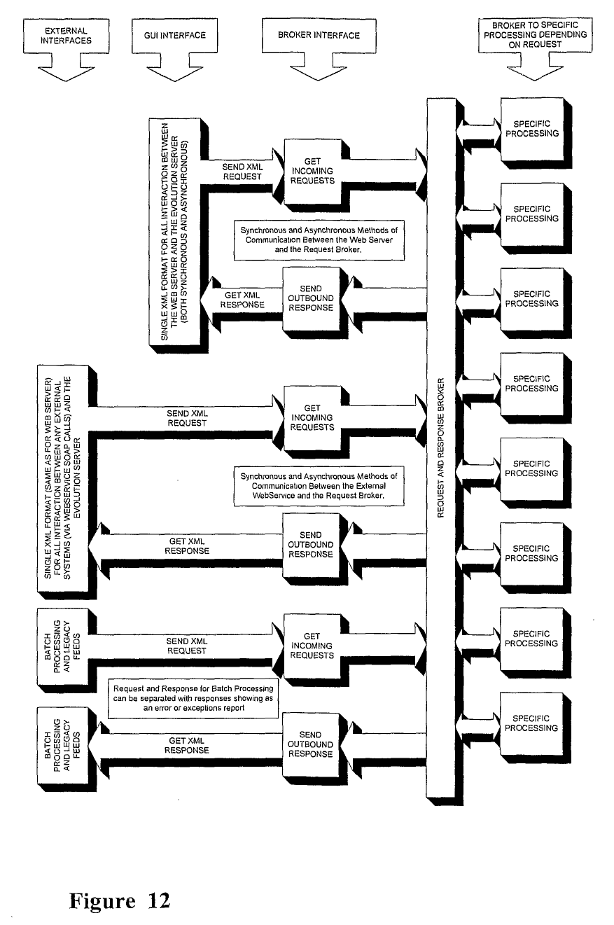

FIG. 12 is a flow Diagram for the Core Request Response Process;

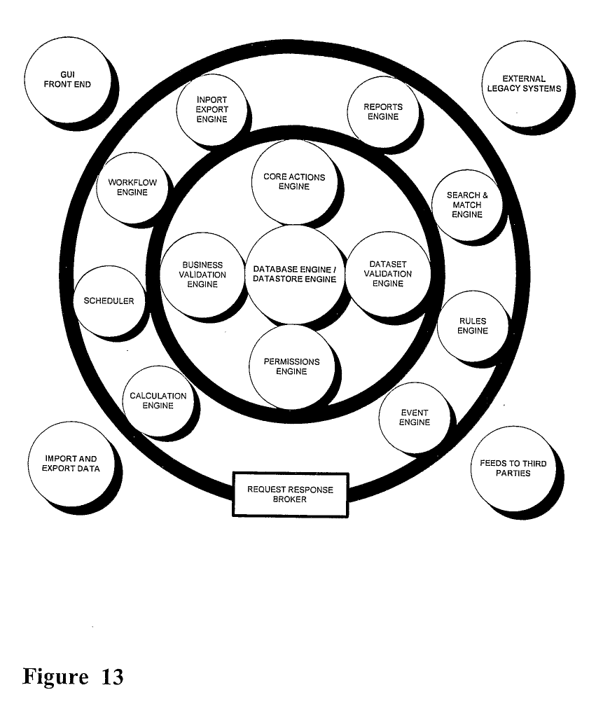

FIG. 13 is a view of the subcomponents of the application control;

and

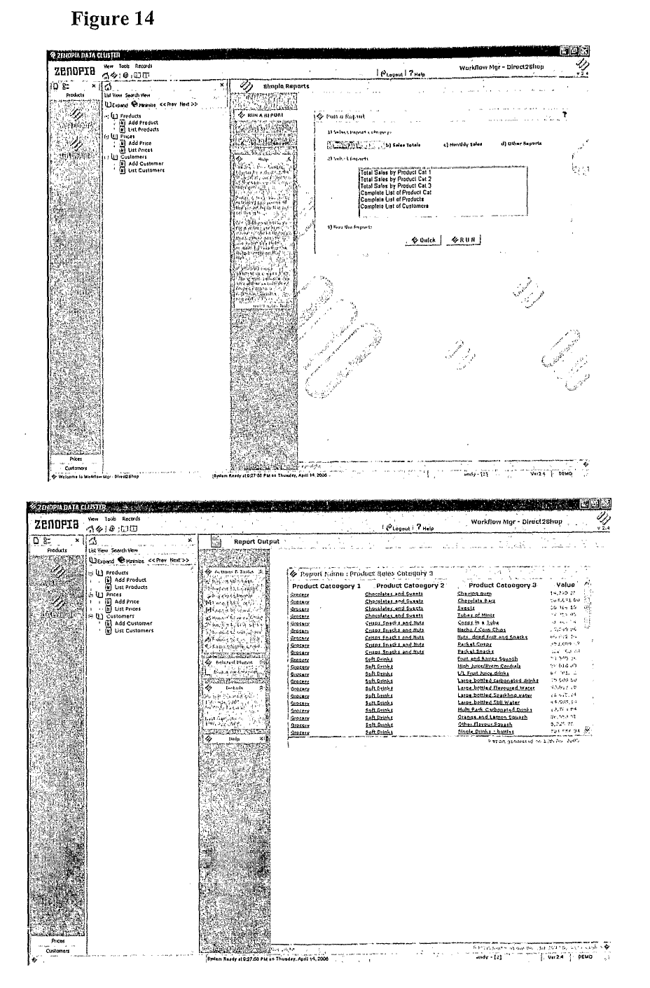

FIG. 14 shows screenshots of Running Reports.

Referring to FIG. 1 there is shown a conventional database table T containing personal information of two employees. As shown here table T could be a simple spreadsheet or could be one of many key related tables in a relational database

The database table T comprises eighteen cells C which contain data values and nine cells C which contain field labels FL. The cells C are set up in the form of a table with rows and columns. Each of the columns represents a field shown by F1, F2 and F3. Each of the rows represent a record R1 or R2. In most relational databases the field labels are not contained as a row of data in the table but merely form an inherent part of the structure and may or may not be stored in s list elsewhere.

All of the databases in the cells within a field are of the same sort of information. For example in field F1 the cells C1 and C2, contain “Fred” and “John” both of which are a person's first name. The first row containing a field label FL merely contains the label for this type of data, in the case of field F1 this is “first name”. Similarly in F2 the field label FL is “last name” and the two cells below it contain examples of last named “Bloggs” and “Smith”.

Each cell C has behind it certain constraints on the type of data which may be entered. For example C1 may stipulate that only text can be entered (since first names are expected to be in the form of text), and may stipulate a maximum length of text such as 20 letters. Similarly in F3 which corresponds with the field label “house number”, the cells below may be constrained to allow only a number and where this number may be faxed as an integer if all known house numbers fall into that category.

Each record R1, R2 contains data which is related. This means that all of the data in a record corresponds to some similar entity. In this example where the table T comprises information on employees, each row R1 or R2 corresponds to an individual employee. Hence in R1 the given individual's name is “Fred Bloggs” and he lives at 2 High Street, Springfield, Milton Keynes and is 34 years of age. The second employee is John Smith at 28 Letsbe Avenue, Edgbaston, Birmingham aged 21. Accordingly, the fact that Smith corresponds with John (i.e. is the last name of an individual with the first name John) is determined by the fact that they are in the same row/record R2. The fact that the entry for Birmingham in C5 corresponds to John again is known because it is in the same row. Accordingly, the relations between data values that reach across the same individual and the knowledge of which sort of category it belongs to is set by the hard coded structure of the table T—that is that the columns represent fields and the rows represent records.

Taken out of the context of the structure the data value does not contain the same information. For example whilst it could still be guessed that the C5 data value “Birmingham” was the name of a city, it would not be known which person it corresponds to, i.e. which record it is in. This can be further demonstrated with the house numbers and age. C6 contains the number “21”, this is a number which could equally well fit into any of the cells in the fields F3 “house number” or F9 “age”. It is known that this is an age of a John Smith by its location within the structure.

Accordingly since the meaning of the data is defined by its position within the structure it is not easily possible to move data values within the structure without affecting the position and meaning of the data contained in it. It is partly for this reason that altering the structure without effecting any data values is technically problematic

Referring to FIGS. 2a and 2b there is showing the same data to be queried as stored in table T but structured and stored in accordance with the invention. As can be seen, the data is stored in a data structure table 10 and in an element storage set 38 which comprises a textual external data table 40 and numerical external data table 60. Here external data is used to mean the data values stored in the database that are to be entered, queried and/or looked at rather than data which exists for the “internal” running of the invention. Such external data will frequently refer to values with a real world meaning. In use for business this might be any information considered part of a business operation or workflow task, and would include by not limited to customer data, sales information, employee data, supplier lists, stock control data, financial information.

The data structure table 10 acts as the complete structural definition of the external data and hence the structure of the external data is in itself stored in the form of data. The content of the external data is stored in tables 40 and 60.

The data structure table 10 comprises a series of twelve rows representing elements 12 and a series of columns which represent individual structural definitions 18.

The first row 20 merely contains labels in a similar manner to the conventional table T, in this instance the labels being “record instance” “element type ID”, “element name”, “data type” and “data type parameters”. Here the labels refer to different sorts of structural information rather than different fields of external data.

There are five individual structural definition columns 18. The first of these contains record instance identifiers 22. The record instance identifier 22 is in effect an identifying tag for a complete structure for a set of external data which is an example of what in the invention is referred to as a record instance 11. Accordingly a record instance 11 corresponds to the structure of a complete conventional table in this example table T. In this illustration table 10 only contains one record instance 11. so that in this column of record instance identifiers 22 the same value is entered for every element 12 that is the “identifier “1”.

The second structural definition 18 is of element type IDs 24 containing data which defines a identifier for each element 12 in the record instance 11 and therefore for each element 12. Elements 12 are substantially equivalent to the fields F of the conventional table T defining a sort/category of data value. The next structural definition 18, third column 26, is for names of elements and contains data values identical to the field labels FL of conventional table T.

The remaining two structural definitions 18 contain data types 30 and data type parameters 32. A data type 30 is a particular classification of data based on the storage requirements. The data values for each different data type 30 are stored separately, as explained below, and therefore the data types 30 define which data belonging to which elements 12 are stored together. The data types 30 act like the “certain constraints on the type of data” of the conventional table T, with the value in the data type structural definition stating the particular classification of data that may be entered in the corresponding portion of the element storage set 38. In this example there are two data types 30 “text” and “numbers”. The invention may use a number to represent the data type such as shown in FIG. 2a where “1” represents a number and “3” represents text. The structure definition 18 (data type parameters 32) indicates further constraints on the data type such as indicating how long the text may be and whether in number must be an integer.

The record instance 11 can be seen to be represented in itself in a conventional table, table 10, having a fixed structure. Here though the structure does not define the structure of the external data but the structure of the structure of the external data. The structure of the external data is defined by the data values in each of the structural definitions 18 of the record instance 11. Accordingly each of the values in each element 12 contains data which is associated with the other data in that row.

The external data itself is stored in the element storage set 38 which is divided into tables for each data type in this case text or number. In this example the text is stored in table 40 and the numbers are stored in table 60.

Textual external data table 40 contains a structured table which contains five columns 42 containing all the data values where the data type 30 is “text”. There are sixteen data rows 44 one for each data value.

The data value column 46 contains two complete sets of records of external data corresponding to all of the textual values that were stored in the cells C of the conventional table T. Each of these forms part of a record sequence 36 which is stored across both tables 40 and 60 (being split into its textual and numerical paths). The first and second record sequences 36 are labelled in FIG. 2b as 36′ and 36″.

The record instance column 48 contains a reference to the particular record instance 11 which defines the structure of the data values, in this case table 10. The value in this column is “1” for all of the data rows 44 making it correspond to the only identifier 22 of table 10.

The element type id column 50 gives the unique identifier of the data row 44 that enables the data row to be mapped to its corresponding element 12. For example in the element type id column 50 of the second data row 52 the element type id is “2”. Mapping this to the record instance table 10—the id “2” acts in a similar manner to a key in a relational database to find the corresponding entry of the element ids 24 stored in record instance 10. It can be see that this value is found in element 16 and therefore the data value “Bloggs” is a “last name”.

The record sequence ID column 54 contains a record sequence identifier 56 which uniquely identifies each value in a given element (e.g.—“Fred” vs “John”) and is preferably shared by values in the each separate “record sequence 36” of data. Accordingly the data from the case sequence 36 which is equivalent to record R1 in the traditional table has a value of “1” in this column whilst the data in the record sequence 36 which is equivalent to record sequence R2 in this table has a value of “2”. In this manner it can be distinguished which data is related to which.

The last column is for element sequence IDs 58. Each cell in this column contains the same reference “1” and the use of element sequences is explained later.

Accordingly when the structured data is pieced together for querying or representing it can be seen that the equivalent to field F1 is built up from the use of the element type id 50 and record sequence ID 54 which identities with equivalent data value and element. It should be noted that the data type 30 and data type parameters 32 are in this instance are alterable data and additionally are related directly to the element 26 and only indirectly by the record instance identifier 48 and element identifier 50 to the data values.

Referring to the numerical external data table 60, this table closely resembles that of table 40. However, it contains the data values of elements 26 which are in number format, and uses the same record sequence identifiers 56 so that together the two tables 40 and 60 contain both record sequences 36 equivalent to records R1 and R2.

The values of external data and the data defining the data structure of the external data are stored in separate places being in tables 40, 60 and record instance 10 respectively. This allows for easy and effective changes to a structure to be technically implemented without affecting the values of the data. Any of the individual cells within any of the tables 10, 40 or 60 can be altered without any significant repercussions. In particular the record instance identifier 48 or record sequence identity 54 of a given data value could be altered without any change to the hard coding of the system, the equivalent to moving a value to a different position in the traditional database table T.

A table such as table 10 may though include more than one record instance and in fact could include all record instances with the record instance column 20 containing different values for each. An example is shown in FIG. 3a where the table includes the record instance of table 10 of FIG. 2 but also a second record instance 13. The elements 12 in the second record instance have a “2” rather than a “1” as their record instance identifier 22. The elements of the second record instance define the structure for different external data analogous to the structure of a second conventional table.

Each record instance can define a different storage set to use, as embodiments of the invention will frequently use multiple storage sets. In FIG. 3b is shown textual external data corresponding to the second record instance being stored in the same storage set 38. For these new values the record instance identifier 22 is a “2” rather than “1”.

Referring to FIGS. 4a and 4b, there is shown an altered form of the tables of FIGS. 2a and 2b. The equivalent features are given the same reference number but preceded by a FIG. 1.

It can be seen that the altered record instance contained in table 110 is substantially similar to the unaltered table 10 but contains three new element 112 these being elements 101, 103 and 105. The names of the new elements for 101, 103 and 105 “middle name”, “country” and “Mother's last name” respectively. Each of these have a new element type identifier 124 which carries on numerically from the end of the old sequence which stopped at nine. Accordingly the new sequence identifiers 24 are “10”, “11” and “12”.

Referring to the textual and numerical tables 140 and 160, it can be seen that they contain the same data as unaltered tables 40 and 60 but with seven new data rows 144 at the bottom of the table 140. Each of these new data rows 191, 192, 193, 194, 195, 196 and 197 contain two new data values, corresponding to two record sequences 36, for each of the three new elements R. The vertical order of data in the table 140 is irrelevant since the data is not defined by its position, but merely by its corresponding record instance identifier 122, element type ID 124 and record sequence identifier 154. This is in contrast to a traditional data base table T where any new data usually would have to be placed in a particular vertical position corresponding to its record and field.

As well as multiple values for each record instance the system allows the ability to have several values for the same element within a single record sequence 36. These are known as element sequences. For example, customer data may have a telephone number field, in the system and this field may allow up to five element sequences to be defined for this field allowing home, mobile, office and fax numbers to be defined as appropriate. The individual element sequences maybe annotated to add the additional descriptive nature of each sequence. There is no upper limit on the number of element sequences allowable.

Referring to FIG. 4b it can be seen that new data rows 191 and 192 have the same element type id 24 in this case the data value “10”. Referring back to the record instances reveals that these two correspond to the element name “middle name” and are therefore the two middle names of Fred Bloggs who has the full name Fred David Charles Bloggs. The two data values are distinguished by having a different entries in the element sequence id 55. As can be seen data row 191 contains a “1” in this column whilst there is a “2” in data row 192.

Referring to FIGS. 5a, and 5b there is shown a second embodiment of altered data. It may be that a user wishes to alter some of the data but not all. For example it could be that the two employees Mr. Bloggs and Mr. Smith work in different departments and that one of the department requires added data whilst the other department does not. In the illustrated example additions are made for Mr. Bloggs but not for Mr. Smith. The equivalent features are given the same reference number as for tables 10, 40 and 60 but preceded by a FIG. 2 or 3.

In this embodiment a second record instance is added. In FIG. 5a is shown a first record instance 211 in a table 210 which is substantially identical to the record instance in table 10. In FIG. 5a is also shown a second record instance 311 in the same table 210 which is substantially similar to the record instance in table 110 except that in the first column 311 all of the record instance identifiers 222 have been changed from “1” to “2”.

As with the embodiment shown in FIG. 4 the numerical external data table 260 is unaltered from table 60 but there are additions to textual external data table 240. Three additional data rows have been added these being rows 284, 285 and 286 which are equivalent to the three new data rows 191, 192 and 193 of table 140 that contained the record sequence id, “1” and have equal to the three new elements 212. Since no new data is required for Mr. Smith and hence the second record sequence there are no additions with the sequence id “2”. The entries of the new data rows 284, 285 and 286 are different from 191, 192 and 193 in that the record instance id 248 reads “2” instead of “1”. Additionally the same change has been made to every data row 244 in which the sequence id, is “1”.

Accordingly the structured data that can be compiled from tables 210 240 and 260 is produced by mapping the data rows with a “1” in the record instance column 248 to first record instance 211 and the data rows, with a “2” in the record instance column 248 are structured according to the definitions in the second record instance 311. This new data has been added selectively without the need for null values in fields as might be the case with conventional databases.

To enable such changes to the record instances to be made before changes to the structured data are enabled a further layer of abstraction can be added by using record types 80 and by versioning as described in detail below.

A record type 80 represents a table that forms the master copy of the structure of that data. That is a record type could be substantially identical to a record instance 11 but no external data tables would link to it directly. Instead when using record types 80 a record instances 11 maybe simply a mapping to a particular record type 80. When the database of the invention is first created for example, the record type 80 may be identical to a record type 11. The record type 80 is the master copy whilst the record instance 10 is the table which defined the current structure of the external data. Using the system allows a record type 80 to be altered or a new record type to be created without immediately effecting the storage or retrieval for querying of the external data. When ready the record instance can be updated to re-map to an altered or new record type 80.

“Versioning” allows old versions of record types 80 and record instances 10 to be available. An example of this is shown in FIG. 6. It can be seen that the record type has three versions, record type 80, version two 82 and version three 84 with a record instance 11, version two record instance 13 and version three record instance 15. In the illustrated example record instance 11 is mapped from record type 81. New versions of both the record type 82 and record instance 13 are then created independently. The second versions of the record instance 13 is altered from the first version 11 without any back reference to the type. For this illustrated example in the second version of the record type 82 may not be use directly to alter the structure data but may simply be an intermediate step in changes being made that are not wished to be enabled (alternatively it may be that a different record instance is mapped to it or that record types can be directly queried and data structure formed from types as described later).

The record type is then altered again and stored as versions three 84. In this example the record instance then maps directly from the third versions of the type 84 to create a record instance versions three 15 ignoring any changes that may have been made to create the second version.

Only when a new version of the record instance is created to map to the new version of the record type does the system start using the new definition

The use of versioning allows for more flexibility in the updating process. As described below it can also be possible to allow a user querying the database to choose which versions of the instance is used. Data values in the external data table will generally default to the versions of the record instance/type to which they were created unless this is altered. This would allow for example data to be updated gradually with the versions of each data row 44 to updated as the data values of the data rows 44 themselves are updated. So for example if in the previous examples John Smith worked in the same department as Fred Bloggs and the new elements were desired to be entered for both but that the data was not yet available for Mr Smith a new versions of the instance 110 could be created with the updated data rows updated to the new version for Mr Bloggs and for Mr Smith the data continues to refer to the old versions until the data is available and entered.

The system allows the data to be displayed/viewed in its original structural form, use the latest version of the structure, or any version in between. Any differences between the old version and the new version can be automatically resolved, with new fields elements being either blank or set to a default or calculated value (based on other information).

The adding of elements for some record sequences and not others would in practice be likely to be done by using versioning rather than creating a new record instance as depicted in FIG. 5. In FIG. 9 is shown how this could be achieved through versioning. Table 410 is substantially similar to table 210 but has an additional structural definition 418, the record instance version column 423. In table 410 there is only one record instance and all of the elements 412 have a “1” entered is the record instance identifier 422. Those elements 433 which correspond to those of first record instance 211 of table 210 have a “1” in the record version instance column 423. The new elements 401, 403 and 405, rather than being created as part of a new record instances have created as a new version of the record instance. Accordingly the elements 437 which correspond to the elements of second record instance 311 of table 210 have a “2” in the record version instance column 423. This means that the system can allow new data analogous to data rows 284, 285 and 386 for “Fred Bloggs” in FIG. 5b to be viewed using the up to date record instance version 437 with old values like those for “John Smith” being viewed using the first version 433.

In FIG. 10 there is shown a preferred embodiment of data storage system and application 1000 in accordance with the invention for storing a database with some or all of the above features. When implemented as a standard three-tier client server arrangement, system 1000 comprises a client PC 1010. and a database engine 1100 both in two way communication with a server 1100. The physical implementation may vary considerably as the system 1000 is designed to be scalable and range from running the Application Server components and the Database Engine 1050 on the same computer or on separate cluster farms.

The system 1000 provides a framework that allows rapid changes to occur without impacting stability or performance of the existing system as code changes to the system to accommodate modifications to the business data structure are not required. The database engine used with system 1000 can be any standard relational database engine, however, performance enhancements maybe gained by using a bespoke database engine that has inbuilt knowledge of the system's data model.

The system enables data to be transformed between structural versions, or merged to new structures altogether. In FIG. 8 is illustrated the merging of two record instances 11 and 86 into one merge instance 88. The merged instance 88 may contain all of the elements 12 of the record instances 11 and 86. In FIG. 8 is shown the reverse with a single record instance 11 being separated into a second record instance 81 and a third record instance 83 which may for example each contain half of the elements 12 of record instance 11 though there may also be element 12 common to both. Once separated the two record instances 81 and 83 can be updated independently as second versions 85 and 87.

In FIG. 11 the server 1100 is shown to comprise web server 1110 and a core server 1120. The core server 1120 comprises a application user interface 1130, application control and configuration 1120, data structure 1150, external data storage 1160, administration component 1170 and a Core 1200.

The core 1200 acts as the central component of the system 1000 and acts as the focus point by which all processing is executed.

The system 1000 can operate as follows:
1) A user U makes a request for information or processing via an action on the user side presentation layer of the system 1000 such a on client PC 1010 or via a call to a web service.
2) This request is sent from the client computer 1010 to the web server 1100 using a conventional mechanism such as HTTP or HTTPS Get or Post
3) The web server 1100 then starts processing this request and at some stage forwards the request to the core 1200. This can be performed by either a synchronous or asynchronous method call passing the calling request as an encoded core message.
4) The core 1200 then reads the core message and determines which component 1130, 1140, 1150, 1160 or 1170 to pass the message/request to.
5) The Core 1200 chooses the appropriate component.
6) The Core 1200 then calls the component 1120, 1130, 1140, 1150, 1160 or 1170 which can process the request and waits for a response.
7) The Core 1200 then returns the response back to the web server 1100, who in turn processes the response and make an appropriate reply to the client computer 1010 such as a HTML page update or refresh.

This forms a high level algorithm of the invention which occurs with any external user U or system action happens upon the invention and a flow diagram for this is shown in FIG. 12.

The system 1000 can provide more that one component function to process the same type of request. This is not appropriate for all requests, but allows the system to select the component best suited at the time. The decision logic for this is based on a number of factors, primarily it is based on the request type, however, additional parameters can influence this. For example the core 1200 monitors itself and the system in general in terms of performance, both actual and predictive. This is particularly useful if some part of the processes can be delayed and processed at a later date when the system performance is better (less activity), an example is to queue updates to the history storage set, and only processed when the system is idle

The core 1200 acts as the only interface between the back-end server components and database and the rendering of the user interface 1130 and/or import and export of data in traditional or common formats (XLS, CSV for example).

The broker 1210 not only manages requests coming from web servers 1110 processing these requests and returning the appropriate data, but monitors the system performance and makes decisions based on these performance metrics. The system is able to split the processing of some requests into real-time and batch components 1230, allowing the system to delay some work until its workload has reduced.

The Core 1200 receives a request and then mediates to the component within the system that can handle that request, the component then performs the specific processing and returns a response that the Core sends back to the calling function within the Web Server.

The Core 1200 can work in a synchronous and asynchronous way, for asynchronous operation the web server (client user interface or web service) makes a request and then continue without waiting for a response to be returned. The response would be sent back to the client via the web server once processing had been completed in the core.

The Core 1200 may event back to the front end system to indicate the success or failure of the request and may return the resulting response, the front end may or may not response to that event.

This allows the bulk or batch processing of requests as well as interactive user actions.

The data structure 1150 comprises a series of record types 80 and instances 11 which may have a similar form to those specific examples depicted in FIGS. 2, 3 and 4. By making the structural definition of data be specified by data or meta data (and not hard coded into the database schema), the system 1000 can allow the structure of a given record sequence 12 to be changed.

The Core 1200 requests a record sequence 36. This starts the generation of a record instance structure representation. Given this, the data for each element of the record instance 11 and sequence 362 is fetched from the element storage set 12 and appended to the structure representation to give a record sequence representation that gets sent back to the Core 1200.

Before fetching the element data from the storage set 38, the tables storing the information that maps the record instances 11 and sequence 30 range to the specific storage set 30 is determined so the query can run against the correct storage set tables.

The system 1000 uses has the concept of “versioning” described above. When external data is loaded into the system 1000 it is done so using a known version of a complete structural definition of the data (record instance 11 and instance version). This gives that particular data an original structural version, however, this does not need to be the most recent or latest version of the defined structure for that type of data.

Information stored about each record type 80 is a record type id and version, a instance key (explained below), parent version and key, record type name and description along with any version specific comments. The parent version and key allow record types to be cloned from other record types 80.

The user interface 1130 is specifically designed to work with the data structure system 1000. The user interface 1130 may be delivered as a thin client (web-based).

The system application rendering is divided into two main tasks. The first is rendering data forms that control and manage the creation and updating of external data. The second concerns any other rendering of application user interfaces such as menus or reports.

However the process used for both is exactly the same, only the difference is the specifics of the request made to the Core 1200 and then mechanism used to transform or translate the responded information into a client side user interface.

The process of rendering data forms based on the external data stored in the system 1000 is as follows:
1.The client facing web server 1110 makes a request to view a given record instance 11 and sequence 36. This is sent to the core and processed, the response returned.
2. The response from the core is in a format (typically XML) which includes the record structure with the data for sequence 36 appended.
3. This XML data blob is transformed into a user interface form (typically HTML) and displayed to the user U of client PC 1010. The transformation being used depends on the type of information being returned.
4. The user is then able to alter elements 12, change statuses etc. and then submit a save.
5.The save then sends a new request back to the system server with the new/updated data.

The system allows users to select the structural version they wish to view the external data. The list of available versions is presented to the user, whereby the user can select a different version (from the one currently being displayed). This actions a request to the Core 1200 to get the structural version requested along with the given record sequence 36 data.

The system application also renders other information sent from the Core 1200 to display menus, organise the layout of the user interface, etc. The process for other type of information is the same, in as much as the request for information (available menus) is send to the Core from the web server, this is processes and returns an XML representation of the available menus, then the web server 1110 converts that information into a format that the client web 1010 browser can render and display as menus the user V can select and activate (which in turn causes an action that sends a request to the Core 1200).

The invention uses XML to represent any data or information that need to be transformed into client side user interface code (HTML, XAML or any derivatives).

The storage of structural information can involve the use of several normal relational database tables. For example the first may define information about the specific record type 80 or instance 11. A second hold information about individual element 12. A third, define the different versions of the structural form for each record type 80 or instance 11. Another table may define levels, which groups subsets of element 12 together.

The original or creation structural definition version may be stored as a reference for a record sequence 11. The original or creation structural definition version of a certain type of data is that which defined the structure of the data when the data was first created (or imported) into the database. Alongside this may be the latest structure for the data record which is the most recent version of the structural definition of a given record instance. This is the defaulting structural version used to display existing data and create new data.

The systems user interface 1130 allows users to view data either in the structural form in which that particular data was created, in the latest structural definition for that record instance, or any structural version available for that record instance 11.

The structural definition allows for various levels to be defined which act as a visual aid in the grouping of related elements 12. The levels can form a hierarchy with levels within levels. Each level may contain elements 12, collections of elements 12 or other levels.

As well as those structural definitions 18 shown in FIGS. 2 to 5 and 9 each element 12 may have recorded properties for data type parameters 32, data type specials (detailed later) as well as all user interface aspects, width, height, format, descriptions.

Another table holds user interface defaults based on the data type 30 and data type parameter 32 values for any given element 26. When new elements 12 are added to each structural definition 18, these default values are used unless the user adding the element 12 overrides them. These defaults include format information, width and height.

Other tables are used to store collections of elements 12, which are grouped together to form related information, which maybe added to multiple structural definitions 18 or whole record instance in one action. One table defines the elements 12 and the collection they are part of, while another table holds details of the collections (id and name). Element collections are normally only used when creating ore updating record types 80.

For each record instance 11, there are zero or more record sequences 12, each uniquely identified by the sequence id value 24.

In addition to the storage of information which specifically relates to the structure of external data, the system 1000 also stores information that maybe used by a Graphical User Interface 1300 forming part of the user interface component 1130. This information relates to aspects of ordering of elements 26 on the display, the size of the element 26, contextual descriptions of the elements.

When the Core 1200 passes a request to deliver the structural definition 18 of a given record instance 10, the following occurs within the component 1130.

Firstly the high level details of the record type 80 is determined by mapping the record instance 10 and latest version back to the record type 80 and record type version. In additional user group (see below) permissions may be checked to determine in the user has sufficient group rights to access this record type.

Next the record levels defined for this record type 80 and version is determined, and again the user permissions determined to see which levels are available.

Then the record elements are selected, the user permissions checked and the resulting element representations added.

If the request for one or more of the record structural definition 18 is required for user input purposes, additional information is added. This includes a list of initial status's available for a new request sequence 36 and a list of any dynamic data lists if any of the elements within the record definition is of type dynamic.

A combined representation of all of this information, the record type 80, the record levels and the record elements 12 are created and returned back to the Core 1200.

Typically the record definitions 18 do not change frequently, and so caching the definitions provides a significant performance advantage. The system refreshes a cache for the definitions whenever updates are made to the structure by the administration systems. The caching mechanism relies on a separate table that simply stores the record instance structural definition representations as XML documents.

Record Instance and Type Keys are used on the record type 80 and instance definitions to enable easy identification of system or application created definitions. A method to allow added elements 12 to be identified as either system or application is also used and simply works by adding an id offset for application generated elements.

The addition of keys and id offsets allow for systematic upgrading of structural definitions 18, which is an important part of any application lifecycle, especially when rolling out enhancements and improvements to specific implementations.

The record structure definitions 18 are assumed to relate to external data stored in the external data storage 1140 in the system 1000. This however doesn't have to be the case. It is possible to create linked record instances where the data either originates or is stored in remote sources.

There are a number of different ways the process of defining and control remote (or linked) data sources can work within the system 1000.
A) Importing with references to remote ids (here the system effectively takes ownership of the data and assumes it to be the master copy for that data)
B) Importing with references to remote ids but use API calls to maintain the state of the data in the remote systems as well. Again here the data in the system is now assumed to be the master copy, but processes are but in place to keep the external data source in line with any changes made.
C) Storage of just the remote ids and then making external API calls to read in the data as required.

As with tables 40 and 60 external data values are stored separated into different data types 30 as defined by the elements 12 within the given record instance 11. Example data types 30 include Integer, Float, Double, Boolean, Alphanumeric, but are not limited to this list.

The data for a single record sequence 36 is segmented onto several physical database tables.

Each table used to store a given data type 30 stores the following information; record instance id 02 record, instance, element type id, element sequence id e4 element data create info (user id and date time), update info (user id and date time) and status indicator.

The columns on the table, create info (user id and date time), update info (user id and date time) and status indicator, are added to every configuration table within the system 1000.

The system 1000 may have many tables each one storing one of the following data types, Boolean, int, float, double, date, binary, text10, text20, text50, text100, text200, text500, text1000, text4000, dynamic, record, level, collection and element. But the system 1000 can be extended allowing new data types to be quickly added.

An additional storage table allows soft context to be added to data rows within any simple record sequence 36. For example if an element in a record instance represented a telephone number and the maximum number of allowable sequences for that element was more than one, the user is able to add some contextual information for each telephone number, saying the first was a home number and the second a mobile and the third a fax machine. The element soft context table contains the request instance id 22 and instance sequence, the element type id 50 and sequence and the soft context data.

Each record instance 10 can define a different storage set to use, as an implementation of this invention typically has more than one storage set.

For finer segmentation of the data, specific sequence ranges can be physically stored on different storage sets 38.

To further extend the scalability of data storage, different storage sets 38 can be physically located on different database engines 1050. Multiple storage sets 38 can be stored on the same database, as the name of each set of tables are unique and based on both the data type 36, storage set 38 and sequence group. Different storage sets 38 may contain different ranges of record sequences based on the same record instance or may contain different record instances. Different storage sets can be stored in the same location in different parts of the memory or in different computers providing they are in communication.

A set of configuration tables are used to defined which storage set a given record instance 61 is using, and the physical database connection details for each storage set 38.

The storage set 38 tables are indexed using the normal database engine indexing on record instance id 82 and record sequence and this provides sufficient performance for data retrieval.

Typically throughout the lifetime of some piece of data, its data type 30 normally remains the same, however the system can manage the process of a data type change.

Options to perform data type changes, include (i) truncate the data and loose any changes made by the user as they exceed the storage capabilities of the data type of the element/data field being changed, (ii) define the data types to exceed the normal storage requires but thus allows slight overfill if require (for example a data type of text length 20 may actually physically be of length 25 to allow for small overflows), (iii) automatically alter the data type for this element when the user tries to save data into an element which can't store the data based on its current data type, or (iv) just indicate the problem and wait for the user to take action (either reduce the data size being updated or modify the data structure manually).

The system 1000 uses all four options in different situations, and typically for different data types. For example in a preferred embodiment for text data types the system automatically manages the process of changing the specific data type (option iii) (which in the case of a text field relates to the maximum length for storage purposes), but for numbers (integers or floats) this is left to the user to modify the structural definition (option iv).

The basic data types 30 can be extended to more specific data types that directly relate to data types available within the database engine. Some data types, like number and text, can been divided into several more specific data types to allow better performance. For example, “Number” can cover three or more actual data types, Integer, Float, Double, depending on the available storage and precision of the implementing database engine

A table is used to map the combination of data type id and data type parameter 32 to the specific storage data type 30.

In additional to normal data types 30 which represent the storage of actual data, the system allows elements to be defined with advanced data types in which the storage table may hold more than one element data field e.g. complex numbers (with a real and imaginary part to them). Advanced data types data types 30 can also be used to map to other data within the system. Such an example of this is a data type that actually maps to another record instance 11 and sequence 36. In the conventional relational databases, this represents a foreign key link to another table. However with system 1000 both the table reference 26 (record instance) and id (record sequence) are stored.

The system has the following linked data types, Records, Levels, Collections, and Elements. Each of these advanced data types are stored in a separate element storage table.

There are two ways in which these linking data types can work. Static linking where the record instance 11 that is being linked to is always the same (for all record sequences), where the element being defined with the linking data type can store the reference to the linked record instance 11 in one of its data link ids. Dynamic linking refers to when the element defined as the linking data type can not store a reference to the linked record instance within the definition. Instead this is stored in the storage table and potentially stores both the linked record instance id and the record sequence. Hence this storage table contains complex data (more than one value).

Dynamic data types enable an element 12 to be an option from a data source. This data source can come from several different areas; creating and store hierarchical lists and sub lists of items, s take a list of record sequences for another record instance, and/or dynamically create a list of options from a bespoke query run on the some underlying data within the system 1000

The dynamic data types are firstly divided to system, application and user lists (although more classes of groups can easily be defined). Each list has a group name. The dynamic groups (detailing the group id and name and class of list) are defined in a database table. The allowable dynamic classes are defined in another table detailing the class code and class name.

System lists maybe generated by running specific queries which are defined in a database table. This table defined the dynamic type id and the sq1 expression to run. For example a select from the user table to get a list of active users.

The groups are mapped to lists by a link table which maps the dynamic group ids with the dynamic lists ids. This table allows a dynamic group to link to another dynamic group allowing any number of levels within the hierarchy. A separate table is used to define the type of grouping or nesting required for a particular dynamic group. For example, the group may just be a combination of all the underlying lists without reference to the list names. Or the list names form a hierarchy (to be displayed on the user interface) and thus need to be nested as such.

An example of this is UK regions (SW, West Midlands, East Midlands, North) as groups and then each group would have a separate list of towns and cities within. A group above the regions links just to the regions groups and is called England, with others called Wales, Scotland etc.

The underlying lists of options are defined in three tables, one defining the list id and name, the next defining the list class (again the list maybe system, application or user) and the third the list values.

Each data type 30 may need specific validation and verification both on the client 1010 side and within the server 1100 side before accepting data changes. The data type specials parameter enables elements to define the type of processing required. For example, an integer maybe an age and so can't be negative, or a text value maybe an email address, telephone number of postcode and so need to validated as such.

The list of different types of special validation depends on the specific application of the system but there are a number of common checks required for any type of application. The validations based on the data type specials are typically performed at three locations within the system, on the client side 1010 (client side scripting), at the web server 1110 and within the system Data Storage component 1100.

Sub-components of the application control 1140 are shown in FIG. 13.

A table containing the all the basic user information, including name, user id, password and primary user group id. A second permissions table maps each user to one or more user groups. The valid user groups are defined in another table. Another table deals with information relating to if a user U is currently logged into the system, and stores information about session ids, last request date and time, and another stores a history of logon and logoff activity for every user.

User groups are managed by two tables, one specify a list of user groups (id's and group names) and another stating the user which owns a given user group (and thus is able to administer it by adding and removing other users from that group).

Additionally all users and groups are associated with an organisation, this allows the combination of user group access from multiple applications to be hosted on the same physical system.

Specifying menus within a user interface application 1130 forms the basis for user workflows and enables users to access functions based on their permissions access rights.

The storage of menus is divided into three main sections, menu class, menu blocks and menu items. The menu class refers to the basic classification and use of a particular set of menus. This invention defines system, application, user, app admin, system admin, top and context but this is defined as data within a menu class table which just gives the class an id and name. A menu permissions table defines which classes are accessible by which user groups and at what level of permission (read only or read write).

For menu class, block and item, attribute tables are defined which allow generic attributes to be assigned to the menus. These attributes are both functional and relate to the user interface. These attributes include but not limited to image names, actions (in the form of code references), ids, etc.

The menu blocks allow menu items to be grouped together in blocks of items with similar functional meaning. A given menu class can have one or more menu block defined. The menu blocks are given an id, name and description. Menu blocks also have permissions based on the application instance (as a given physical implementation of the system may host more than one application). So only certain menu block are available to certain applications.

Note, when new record instances 11 are created when new data is imported into the system, the system automatically creates a new menu block data to specify new application menus that enable the new data to be control and managed (updated).

The menu items themselves specify individual menu actions. Three tables for the menu items details the menu item (id and name), the associated attributes which can include menu item images, actions and other GUI properties such as hover over tool tips, and the menu item permissions.

The system 1000 provides several ways for users to search data within record instances 11/sequences 36. The system 1000 stores information on which elements 12 within each record instance IF should be used to search on. This enables the system 1200 to render search boxes for each of the elements 12 specified and to include criteria operators.

Search results are typically returned as a list of record sequences that match the search criteria. The displayed information is based on a record label. The record label specifies a combination of record elements that when combined form a human readily unique identifier for that particular record sequence.

The system 1000 enables reports to be defined that run against the external data defined within the system 1000. A screenshot of running such reports is shown in FIG. 14. A number of report configuration tables are used to specify the details of the reports including the elements 26 of record instances 10 to return as columns within the report, search filters to apply to the record sequences again based on specified elements 12 and values to match, functions to run to generate summary information (sum/average), elements 12 to group by when running the query, links to include to allow drill down style reports (a value on one report being clickable and causing the running of another report).

The system has the concept of dynamic reports. These are reports that are re-run and displayed when a workflow event or action occurs allowing them to be delivered in real time.

The system 1000 provides a framework for user and data workflows. This is primarily based on record sequence statuses and record instance status state transitions.

For a given record instance one or more statuses are defined as valid statuses for that record instance. These statuses are also permission based on the user groups. A collection of statuses are defined for each record type, then for a record instance based on that record type additional statuses can be added or others removed. Statuses also have a status type which is related to the application key for different applications hosted within one implementation of the system.

Workflow events are triggered by status transitions. For each record instance 11, a set of workflow definitions are configured that state the start and end status id and the workflow event id to action. The workflow event ids can action a number of different tasks. These can be system batch processing tasks or more interactive tasks, such as updating a dynamic report.

The system Core checks the status changes when any business data is updated against the workflow definitions and action any additional processing as required.

Events are defined as dynamic processing that happens within the data form as the user modifies or updates data. Elements 12 within the record instance 11 being processed can be flagged as elements that require validation, calculation or action.

So as the user make a change to one element data value, the system makes a round trip to the server 1100 to either validate the value entered, perform a calculation (which may either alter the value of the element changed or other elements in which the calculate includes, or an action to for example alter the values in a dynamic drop down option list).

If an element 12 is flagged as requiring validation, the validation id is specified which maps to the desired function to apply to verify the data. Validation is performed on the element being acted upon by the user.

For calculations, one or more elements 12 are used as sources to the calculation and one element 12 is flagged as the result element of the calculation. Thus is any of the source elements date acted upon by the user, the system triggers the calculation and repopulates the result element with the output of the calculation. An element 12 may have a validation and be the source or result element of a calculation. Validation is performed before firing a calculation if the element is a source.

If an element 12 is flagged as an action event, the change of value is used by the action which typically modifies the value of another element.

The system has various mechanisms to deal with importing, merging and exporting data. The Core 1200 provides a way to bulk insert record sequences 36 via a web service or similar method, this allows data from remote sources to be imported into the system. Merging data within the system can be done either by creating new record types with linked elements (linked data types to other elements in other record types), or by directly copying the data from the source record types into a new merged definition record type as depicted in FIG. 7. Exporting of data is achieved through web service requests to the Core.

The same process is applied by this component as for others when requests from the Core 1200 received. Essentially the request id and request parameters are queried and the appropriate function called. The response returned by the function call is then returned back to the Core 1200.

Administration of the system by administration component 1120 includes several areas to enable the smooth operation of the application and system

Configuration of the system is exclusively done by process using the Core mechanism to perform any type of administration function, for example, adding users, updating record structure, adding statuses, modifying dynamic data types.

The core actions themselves is defined by system configuration data and enables additional admin features/processes to be easily added to the system.

Typically this system process involves the manipulation of system or application configuration data, and in a simple form wraps the calling of a database engine stored procedure. The core actions can be dynamically generate an input form with various fields available for the admin user to enter new data in or update existing data. The specifics of the input form vary depending on the core action being executed.

The system has a number of tables which store the configuration details for the core actions, these include, the process they execute, the input attributes requires, default values, option lists, bespoke queries to run on the database for certain core action fields. Also defined are configurations to group certain core actions together to form logical sets of operations allowing them to be grouped together on the administration application menus.

The system can then define a set of core actions that maintain the core action configuration tables, giving the administration application users the functionally to add any new or previously unused core actions to the admin application.

The system hosts an admin application that provides access to all the core actions which help to administer the system and applications hosted by it. This application has menus grouped by functional areas relating to system and application configuration and they activate specific core actions.

Each core action presents the user with a data form (similar to the data formed used to manage business data). The admin user can then input or update data (for example adding a new user to the system) and then by pressing the Save button sends the new data to the system Core 1200 for processing.

Due to the complexes of making everything within the system configurable, a the types of admin functions are perfectly layered, so that only advanced configuration tasks are accessible by users trained to perform those tasks.

The system also provides a system admin portal for more technical monitoring of the system. These include monitoring of data feeds for linked records, Core requests and responses, automated data importing, data access web services.

The administration application may have the concept of a model, which is essentially a whiteboard for a record type 80 to be updated. This enables a record type structure to be copied to the model, modified and saved without saving it as a new version of that record type. This enables record type structure prototyping to be performed, and multiple updates and changes to be made before the structure is saves as a new version of the record type and then possible published as a new version of any record instances.

The record type, level and element details are isolated within the model whiteboard

With any application, having historical information can be important both for analysis and auditing. The system maintains history for all data, both business data and application configuration data. This is achieved in four ways.

Firstly, all data tables (application configuration data) have a created date, created user id, an updated date, an updated user id and a status field. These are used to give a basic audit trail.

Secondly, the system persists all Core requests and responses. This helps to give an indication of the system activity. The details of these are made available through the system portal.

Thirdly, all business data structure changes are versions, the update user id, update date time stored for each change made. Admin core actions allow the version details to be displayed.

Fourthly, all changes to the business data values are recorded in a separate set of history storage sets. Access to the history business data is via the system portal.

The same process is applied by this component as for others when requests from the Core 1200 are received. Essentially the request id and request parameters are queried and the appropriate function called. The response returned by the function call is then returned back to the Core.

Whilst in the above example “internal” data i.e. data definitions etc are described as being stored in a conventional manner, the data storage model for the external data can be applied to all of the data including data definition.

1. A data storage apparatus, for allowing querying of structured data, in which the structure of the data and the values of the data are stored separately,
the apparatus comprising a computer system including a memory, queryable structured data, a plurality of records of related data values stored in a first location of the memory and a structural definition data stored in a second location in the memory each record of related data values comprising a sequence of data values, each data value in the record having a stored definition identifier which corresponds to at least a portion of the structural definition data and a record sequence identifier, the record sequence identifier being the same for related data values within the same record,
wherein the queryable structured data comprises the records of data values set to a structure defined by the values' corresponding portion(s) of structural definition data and the corresponding record sequence identifiers, such that the structure of the data and the data values can be altered independently by altering one or more of the structural definition data, the sequence of data values and the definition identifiers.

2. The data storage apparatus according to claim 1 wherein data values from different ones of the plurality of records are stored together such as in a single table.

3. The data storage apparatus according to claim 1 wherein the structural definition data contains a data type for each portion associated with an identifier, which data type defines the category of the corresponding data value such as text or number.

4. The data storage apparatus according to claim 3 wherein data values in the record sequence with different corresponding data types are stored separately such as in different tables.

5. The data storage apparatus according to claim 3 wherein the plurality of record sequences stored in the first location are stored as a storage set, the storage set comprising a separate data unit, such as a table, for all values across the plurality of sequences with a given corresponding data type in the structural definition.

6. The data storage apparatus according to claim 1 wherein the plurality of record sequences stored in the first location are stored as a storage set, the storage set comprising a separate data unit, such a table, for all values across the plurality of sequences that are of the same data type.

7. The data storage apparatus according to claim 5 comprising a plurality of storage sets.

8. The data storage apparatus according to claim 7 wherein storage sets are stored in different parts of the memory and/or on different database engines.

9. The data storage apparatus according to claim 7 wherein the different storage sets contain different record instances and/or different ranges of record sequences within the same record instance.

10. The data storage apparatus according to any claim 7, wherein the memory has a configuration table use which defines one or more of which storage set at a given record instance uses and the physical database connection details for each storage set.

11. The data storage apparatus according to claim 3 wherein the storage of data and data structure in the system is configured so that the data type can be altered such as to capture a new sequence of data.

12. The data storage apparatus according to claim 1 wherein the computer system comprises a master copy of the structural definition stored in the memory and an operable copy of the master copy of the structural definition which can be mapped from the master copy in operation.

13. The data storage apparatus according to claim 1 wherein the computer system comprises a plurality of versions of the structural definition stored in the memory, wherein the system allows for querying of a structured data which comprises the sequence of data values set to a structure defined by the values corresponding portion(s) of any of the versions of the structural definition data.

14. The data storage apparatus according to claim 13 wherein each of the plurality of versions are time stamped so that the order of their creation can be determined.

15. The data storage apparatus according to claim 13 wherein there is stored in the memory a plurality of versions of the master copy and/or the operational copy.

16. The data storage apparatus according to claim 1 comprising a user interface which can take queries from a user and return results to a user based on the structured data.

17. The data storage apparatus according to claim 14 wherein the computer system comprises a master copy of the structural definition stored in the memory and an operable copy of the master copy of the structural definition which can be mapped from the master copy in operation and wherein the user interface is configured to allow the user to choose the versions of the structural definition to be used to define the structure of the structured data for returning a result.

18. The data storage apparatus according to claim 12 wherein one or more and preferably each data value or sequence/record of data has an identifier which corresponds to a version of structural definition with a time stamp that relates to the creation time of the one or more and preferably each data value, or sequence/record.

19. The data storage apparatus according to claim 1 wherein the structural definition comprises a plurality of elements, each data value in a sequence comprising an element identifier, wherein the queryable structured data comprises the records of data values set to a structure defined by the values' corresponding portion(s) of structural definition data and the corresponding element identifiers.

20. The data storage apparatus according to claim 19 wherein the structural definition data contains the data type for each portion associated with an identifier, which data type defines the category of the corresponding data value such as text or number and wherein the data type set for each element.

21. The data storage apparatus according to claim 19 wherein the same element identifier(s) is shared by data values in one or more of the plurality of records.

22. The data storage apparatus according to claim 19 wherein the storage of structural definition is configured so that an element can be added, deleted and/or amended without affecting the data stored in the first location.

23. The data storage apparatus according to claim 20 wherein elements are defined in collections and a collection may be added to the structural definition in a single step.

24. The data storage apparatus according to claim 5 wherein the structural definition or an element in a structural definition may contain data type parameters to accompany the data type so that any data value stored in the first location with identifiers which are associated with that data type are confined by the restraints of the parameters of the data type parameters such as the a maximum number of characters.

25. The data storage apparatus according to claim 1 wherein the computer system comprises a plurality of components and a central core functionality wherein all the interactions and processing of the database by a user is done via the central core, wherein the central core functionality determines and instructs the appropriate component.

26. The data storage apparatus according to claim 25 wherein the components comprise one or more of external storage, which hold the set of data stored in the first location, data structure, which holds the structural definitions, an administration component or a application control component.

27. The data storage apparatus according to claim 1 wherein the structural definition comprises a parent key, enabling the definition to be cloned.

28. The apparatus of claim 1 wherein the system element definitions are identifiable through the use of instance and type keys from application element definitions, enabling the system upgrading of record definitions to happen without affecting any application or implementation elements added.

29. A method of storing data in a memory of a computer system for allowing the querying of structured data, comprising the steps of:
storing the structure of the data and the values of the data separately, by storing a sequence of data values in a first location of the memory and a structural definition data in a second location in the memory, each data value in the record having a stored definition identifier which corresponds to at least a portion of the structural definition data; and
compiling queryable structured data from the sequence of data values set to a structure defined by the values corresponding portion(s) of the structural definition data, such that the structure of the data and the data content/values can be altered independently by altering the structural definition data or sequence of data values respectively or by altering one or more definition identifiers.

30. (canceled)

31. A data storage apparatus, for allowing querying of structured data, in which the structure of the data and the values of the data are stored separately, the apparatus comprising a computer system including a memory,
a sequence of data values stored in a first location of the memory and a structural definition data stored in a second location in the memory, each data value in the record having a stored definition identifier which corresponds to at least a portion of the structural definition data, wherein the queryable structured data comprises the sequence of data values set to a structure defined by the values corresponding portion(s) of the structural definition data, such that the structure of the data and the data content/values can be altered independently by altering the structural definition data or sequence of data values respectively or by altering one or more definition identifiers.
